(19) United States
(12) Patent Application Publication
(10) Pub. No.: US 2024/0278725 A1
(43) Pub. Date: Aug. 22, 2024

(54) PERFECTED LADDER FOR MOTOR VEHICLES AND ASSEMBLY METHOD THEREOF

(71) Applicant: TAKLER S.R.L., Altamura, Bari (IT)

(72) Inventor: Lorenzo LORUSSO, Altamura, Bari (IT)

(21) Appl. No.: 18/567,623

(22) PCT Filed: Jun. 7, 2022
(86) PCT No.: PCT/IB2022/055272

§ 371 Date: Dec. 6, 2023

(30) Foreign Application Priority Data
Jun. 7, 2021 (IT) 102021000014717

(51) Int. Cl. B60R 3/00

(52) U.S. Cl. CPC B60R 3/007

(57) ABSTRACT

A ladder includes a pair of uprights, directed along a prevailing vertical direction. The uprights are connected to each other by at least one cross member, perpendicular to the uprights, directed along a transverse direction, perpendicular to the vertical direction. The cross member acts as a step of the ladder in which the uprights include coupling portions at the upper fixing ends. The coupling portions have two horizontal planes and a vertical joining rib, to present overall a ‘C’ shape, and the coupling portions are provided with at least one fixing hole for inserting at least one fixing bolt of the ladder to an associable chassis.

### FIELD OF APPLICATION

The present invention relates to a perfected ladder for motor vehicles, typically for motor vehicles for transporting goods such as, for example, trucks, lorries, trailer trucks, trailers and the like, and the related assembly method of said ladder.

### BACKGROUND ART

As known, at the loading compartments or tipper dump bodies, motor vehicles are provided with a ladder to facilitate the climb up to the loading plane, by an operator.

Typically such ladders are provided with one or more steps and are welded to the chassis of the motor vehicle or its loading plane.

Fixed ladders of the prior art are subjected to notable wear and deterioration, also because they are fixed and therefore exposed to atmospheric agents throughout the use of the motor vehicle.

Therefore, with prolonged use, it often happens that one or more steps can get damaged or detached. In this event, the destructive disassembly of the ladder is necessary, which usually takes place by desoldering or cutting the walls of the ladder connected/welded to the chassis of the motor vehicle.

Therefore, in the prior art it was proposed to provide removable ladders that can be removed when not needed, so as to limit the wear and extend the useful life thereof.

However, ladders must be provided which can be assembled and disassembled very quickly, considering that the driver of the motor vehicle must be able to access the loading compartment repeatedly during the use of the vehicle and must not waste time in the ladder assembly and disassembly operations.

At the same time, the removable ladder solutions must also guarantee the necessary safety standards, despite the speed and assembly and disassembly simplicity.

Known solutions cannot guarantee fulfilment of the mentioned requirements for ease of use, assembly and disassembly speed, while complying with adequate safety standards.

### PRESENTATION OF THE INVENTION

Therefore, the need is felt to solve the drawbacks and limitations stated above with reference to the prior art.

Such a need is met by a ladder according to claim 1.

### DESCRIPTION OF THE DRAWINGS

Further features and advantages of the present invention will become more comprehensible from the following description of preferred embodiments thereof, given by way of non-limiting examples, in which:

FIG. 1 shows a perspective view from a first angle of a ladder, assembled on an associable vehicle, according to a possible embodiment of the present invention;

FIG. 2 shows a perspective view, from a different angle, of the ladder of FIG. 1;

FIG. 3 shows a perspective view of a ladder, in the disassembly configuration, in accordance with a possible embodiment of the present invention;

FIG. 4 shows a perspective view of a ladder, in the disassembly configuration, in accordance with a further possible embodiment of the present invention.

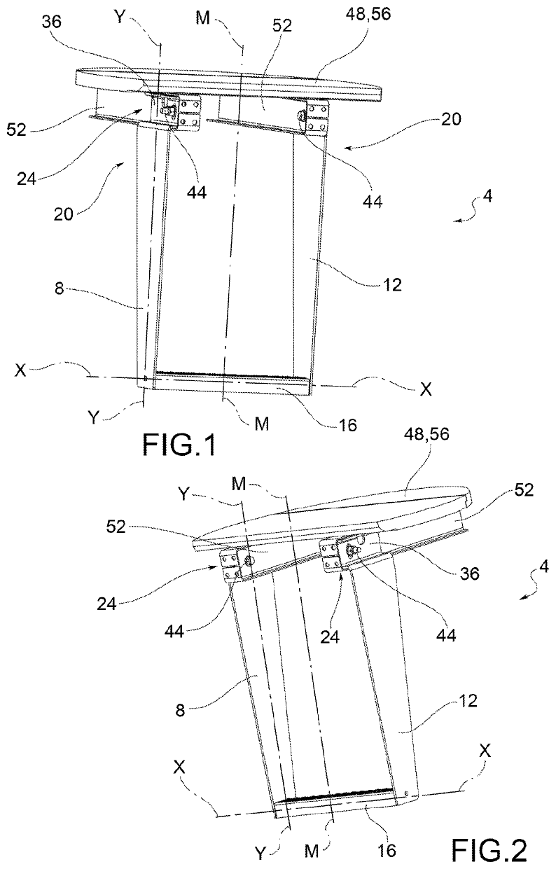

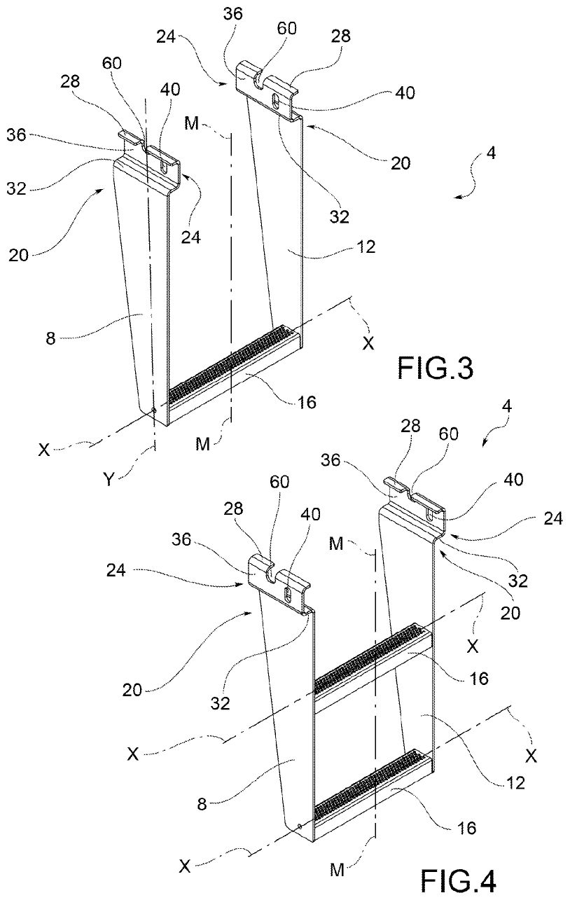

The elements or parts of elements common to the embodiments described below will be indicated using the same numerals.

### DETAILED DESCRIPTION

With reference to the aforesaid drawings, a ladder is indicated by numeral 4 as a whole.

Said ladder 4 comprises a pair of uprights 8,12, directed along a prevailing vertical direction Y-Y, wherein the uprights are connected to each other by at least one cross member 16, perpendicular to the uprights 8,12 themselves.

The cross member 16 is directed along a transverse direction X-X, perpendicular to said vertical direction Y-Y; the cross member 16 acts as a step of the ladder 4.

Preferably, the ladder 4 comprises one or two cross members 16, i.e. one or two steps.

The uprights 8, 12 comprise coupling portions 24 at the upper fixing ends 20.

Said coupling portions 24 comprise two horizontal planes 28, 32 and a vertical joining rib 36, so as to present overall a ‘C’ shape.

The coupling portions 24 are also provided with at least one fixing hole 40 for inserting at least one fixing bolt 44 of the ladder 4 to an associable chassis 48 of a vehicle.

In particular, the coupling portions 24 are shaped to engage with a side member 52 of a floor 56 of an associable vehicle.

According to a possible embodiment, said coupling portions 24 are at least partially flexible in a vertical Y-Y direction, so as to allow coupling to a side member 52 of a floor 56 of an associable vehicle.

In general, the side members 52 may have various sections and the coupling portions 24 of the ladder are counter-shaped to said sections. Preferably, the side members have IPE sections, i.e. I-shaped or double T-shaped; alternatively, it is also possible to provide side members having different sections such as, for example, an I-shaped or rectangular section; in the latter case the coupling portions 24 are counter-shaped with respect to the base and height of said rectangular section.

Preferably, the coupling portions 24 are arranged symmetrically with respect to a centreline plane M-M of the ladder, perpendicular to said transverse direction X-X.

According to a possible embodiment, the coupling portions 24 are arranged in such a way as to have the respective vertical joining ribs 36 in an external position, on the opposite side of the centreline plane M-M, to the corresponding uprights 8,12. Such conformation is suitable for chassis 48 in which the respective side members 52 are arranged at an enlarged pitch from each other, or anyway a greater pitch than the transverse width of the cross member 16 of the ladder 4.

According to a further possible embodiment, the coupling portions 24 are arranged to present respective vertical joining ribs 36 in internal position, on the same side of the centreline plane M-M, as the corresponding uprights 8,12. Such conformation is suitable for chassis 48 in which the respective side members 52 are arranged at a narrow pitch from each other, or a smaller pitch than the transverse width of the cross member 16 of the ladder 4.

Preferably, said fixing hole 40 is arranged on each vertical joining rib 36 of the coupling portions 24.

According to a possible embodiment, at least one of said horizontal planes 28, 32 is provided with a recess 60. Said recess 60 is preferably shaped so as to prevent any interference with projecting portions of the chassis 48 and/or of the side members 52.

According to a possible embodiment, said uprights 8, 12 are at least partially elastically flexible, in the transverse direction X-X, so to as allow elastic spreading or squeezing of the coupling portions 24 along said transverse direction X-X.

The ladder 4 may be made of any material; preferably it is made of metal material. According to a possible embodiment, the ladder 4 is made of hot galvanised carbon steel.

The assembly/disassembly of a ladder according to the present invention will now be described.

In particular, the assembly envisages juxtaposing said ladder 4 to the side members 52 of the floor 56 or chassis 48 of the vehicle, so as to engage each of said coupling portions 24 to a corresponding side member 52.

This step envisages elastically spreading out or juxtaposing the coupling portions 24 to the side members 52 in such a way as to allow the ladder 4 to be fixed to the side members 52 by means of a shape coupling between the coupling portions 24 and said side members 52 and to allow the subsequent insertion of fixing screws or bolts 44 passing through the fixing holes 40 and corresponding holes made on the side members 52 or on parts of the chassis 48 of the motor vehicle that are adjacent to the side members 52.

The juxtaposition ad elastic deformation of the uprights 8,12 and/or of the coupling portions enables the ladder 4 to be adapted to chassis 48 and/or to side members 52 of different sizes or anyway to consider the possible tolerances of the structures to which the ladder 4 is to be coupled.

As can be appreciated from the above description, the described solutions allow the drawbacks presented in the prior art to be overcome.

In particular, the ladder according to the present invention can be assembled and disassembled quite practically and quickly by a single operator, without using any specific tools.

The assembly/disassembly operation can be repeated various times during the use of the motor vehicle also on the same day, without this implying any significant slowing down of the loading/unloading of goods.

The ladder is therefore safe in relation to safety standards, while still being removable.

In the event of a step of the ladder breaking, the operator can easily replace the step by simply removing it from the chassis of the motor vehicle, without using any specific tools and without having to destroy/remove any welded parts.

For the purpose of meeting contingent and specific requirements, a person skilled in the art may make numerous modifications and variations to the solutions described above.

The scope of protection of the invention is defined by the following claims.

1. A Ladder comprising:
a pair of uprights, directed along a prevailing vertical direction,
said uprights being connected to each other by at least one cross member, perpendicular to said uprights, directed along a transverse direction, perpendicular to said vertical direction, said cross member acting as a step of the ladder, wherein:
the uprights comprise coupling portions at the upper fixing ends,
said coupling portions have two horizontal planes and a vertical joining rib, to present overall a ‘C’ shape,
said coupling portions being provided with at least one fixing hole for inserting at least one fixing bolt of the ladder to an associable chassis.

2. The ladder according to claim 1, wherein said coupling portions are shaped to engage with a side member of a floor of the associable vehicle.

3. The ladder according to claim 1, wherein said coupling portions are at least partially elastically flexible in the vertical direction, to allow coupling to a side member of a floor of an associable vehicle.

4. The ladder according to claim 1, wherein said coupling portions are arranged symmetrically with respect to a centreline plane of the ladder, perpendicular to said transverse direction.

5. The ladder according to claim 4, wherein said coupling portions are arranged to present the respective vertical joining ribs in an external position, on an opposite side of the centreline plane, to the corresponding uprights.

6. The ladder according to claim 4, wherein said coupling portions are arranged to present the respective vertical joining ribs in an internal position, on the same side of the centreline plane, as the corresponding uprights.

7. The ladder according to claim 1, wherein said at least one fixing hole is placed on one of the vertical joining ribs.

8. The ladder according to claim 1, wherein at least one of said horizontal planes is provided with a recess.

9. The ladder according to claim 1, wherein said uprights are at least partially elastically flexible, in the transverse direction, to allow elastic spreading or squeezing of the coupling portions along said transverse direction.

10. The ladder according to claim 1, wherein said ladder is made of hot galvanised carbon steel.

11. An Assembly method of a ladder comprising the steps of:
providing a ladder according to claim 1,
providing a vehicle having a floor and a plurality of side members parallel to each other,
juxtaposing said ladder to the side members, so as to engage each of said coupling portions to a corresponding side member,
attaching the ladder to the side members by fixing screws or bolts passing through said fixing holes of the fixing portions and corresponding holes made on the side members or on parts of the chassis of the vehicle adjacent to the side members.

12. An Assembly method of a ladder according to claim 11 comprising the steps of:
elastically spreading out or juxtaposing the coupling portions to the side members of the vehicle to allow the ladder to be fixed to the side members by a shape coupling between the coupling portions and said side members and to allow the insertion of fixing screws or bolts passing through the fixing holes and corresponding holes made on the side members or on parts of the chassis of the vehicle adjacent to the side members.
